(19) United States
(12) Patent Application Publication
(10) Pub. No.: US 2025/0320364 A1
(43) Pub. Date: Oct. 16, 2025

(54) COMPOSITE COATING LAYER, COATING STRUCTURE AND HEATING DEVICE HAVING THE COMPOSITE COATING LAYER

(71) Applicant: INDUSTRIAL TECHNOLOGY RESEARCH INSTITUTE, Hsinchu (TW)

(72) Inventors: Wu-Han LIU, Miaoli City (TW); Wei-Tien HSIAO, Zhudong Township (TW); Chang-Chih HSU, Hsinchu City (TW); Mao-Shin LIU, Zhudong Township (TW); Zhong-Ren WU, Taichung City (TW); Ming-Sheng LEU, Zhudong Town (TW)

(73) Assignee: INDUSTRIAL TECHNOLOGY RESEARCH INSTITUTE, Hsinchu (TW)

(21) Appl. No.: 18/399,397

(22) Filed: Dec. 28, 2023

(51) Int. Cl. C09D 5/38; A47J 36/02; B05D 5/08; B05D 7/24; C09D 5/08; C09D 201/00

(52) U.S. Cl. CPC C09D 5/38; B05D 5/08; B05D 7/24; C09D 5/084; C09D 201/00; A47J 36/025; B05D 2202/15; B05D 2202/25; B05D 2203/30; B05D 2210/00

(57) ABSTRACT

A coating structure includes a composite coating layer over a substrate. The composite coating layer includes 4.3 wt % to 7.6 wt % carbon (C), 9.5 wt % to 21.8 wt % oxygen (O), 1.2 wt % to 3.5 wt % aluminum (Al), 23.5 wt % to 42.6 wt % titanium (Ti), 16.8 wt % to 41 wt % nickel (Ni) and 14.3 wt % to 23.7 wt % zirconium (Zr). The composite coating layer includes a rough surface, and the surface roughness of the rough surface is in a range of 1 μm to 50 μm.

### TECHNICAL FIELD

The disclosure relates to a composite coating layer, a coating structure, and a heating device having a composite coating layer.

### PRIOR ART

Affected by the breakout of epidemic diseases in recent years, people have reduced the amount of time they spend eating out. As a consequence, the frequency of cooking and preparing meals at home has increased. Consumer demand for cooking-related supplies has also grown significantly. According to Asian cooking habits, such as stir-frying, frying, and braising, the frying pans, nonstick pans, woks, and the like are among the most popular cooking utensils in terms of sales. Among these, pots with nonstick properties are a favorite choice of consumers. Typically, a coating layer is formed on a thermally conductive substrate of the pot. The coating layer provides the nonstick properties of the pot. In addition, other properties of the pot, such as rapid heating speed, thermal uniformity, abrasion resistance and corrosion resistance, are also key factors that consumers consider prior to making a purchasing decision.

However, not all commercially available cooking utensils have all of the above properties. For example, some conventional coatings that contain aluminum alloy do not have long-lasting abrasion resistance and corrosion resistance. In addition, some conventional coatings that have single quasicrystal phase are difficult to coat on aluminum-containing substrates due to their hard and brittle properties, which increases the technical difficulty of production and leads to a relative high production cost. In addition, some conventional coatings that include polymer material (such as Teflon) and/or silicone oil have nonstick properties, but these conventional coatings have low hardness, poor abrasion resistance and poor thermal conductivity.

In addition, the mass production technology of conventional coatings also has limitations. For example, high temperature annealing (at approximately 700° C. to 900° C. or another suitable temperature) may be performed during the process of coating chemical materials on pot substrates, but not all of the substrate materials are suitable for being heated to the high temperatures needed for annealing. Taking aluminum substrates as an example, the above-mentioned annealing temperature is higher than the melting point of pure aluminum of about 660° C., and the current melting point of general aluminum alloys does not exceed 700° C. Therefore, coating mass production technology that includes high temperature annealing treatment is more suitable for coating layers on iron-based surfaces, and is not suitable for coating layers on aluminum-based pots. In addition, for those conventional coatings that are formed by melting raw material powder and spraying it on the surface of a pot base material, most of the quasicrystals in the powder are converted into amorphous or another hard phase, which significantly reduces the nonstick properties of the coating.

Therefore, how to develop a coating layer with the properties of nonstick, good thermal uniformity, abrasion resistance and corrosion resistance and also its preparation method that reduces the limitations of the application base materials (for example, applicable to aluminum bases that are not thermally stable under a high-temperature annealing treatment) is one of the important objectives of manufacturers.

### SUMMARY

Some embodiments of the present disclosure provide a composite coating layer that includes 4.3 wt % to 7.6 wt % carbon (C), 9.5 wt % to 21.8 wt % oxygen (O), 1.2 wt % to 3.5 wt % aluminum (Al), 23.5 wt % to 42.6 wt % titanium (Ti), 16.8 wt % to 41 wt % nickel (Ni) and 14.3 wt % to 23.7 wt % zirconium (Zr).

Some embodiments of the present disclosure provide a coating structure that includes a substrate and a composite coating layer over the substrate. The composite coating layer includes 4.3 wt % to 7.6 wt % carbon (C), 9.5 wt % to 21.8 wt % oxygen (O), 1.2 wt % to 3.5 wt % aluminum (Al), 23.5 wt % to 42.6 wt % titanium (Ti), 16.8 wt % to 41 wt % nickel (Ni) and 14.3 wt % to 23.7 wt % zirconium (Zr). The composite coating layer includes a rough surface, and the surface roughness of the rough surface is in a range of 1 μm to 50 μm.

In addition, some embodiments of the present disclosure provide a heating device that includes the aforementioned composite coating layer.

### BRIEF DESCRIPTION OF the DRAWINGS

FIG. 1 is a schematic cross-sectional view of a coating structure, in accordance with some embodiments of the present disclosure.

FIG. 2 is a schematic cross-sectional view of another coating structure, in accordance with some embodiments of the present disclosure.

FIG. 3 is an X-ray diffraction pattern of a composite coating layer, in accordance with some embodiments of the present disclosure.

FIG. 4 shows graphs of weight loss of each of the composite coating layers at different rubbing times in some of the dry sand abrasion tests according to the present disclosure.

FIG. 5 shows graphs of surface temperature distribution of a commercial stainless steel pot that is heated to a temperature of 200° C., in accordance with some experimental tests of the present disclosure.

FIG. 6 shows graphs of surface temperature distribution of a commercial pure aluminum alloy pot that is heated to a temperature of 200° C., in accordance with some experimental tests of the present disclosure.

FIG. 7 shows graphs of surface temperature distribution of a commercial nonstick pot with conventional nonstick coating that is heated to a temperature of 200° C., in accordance with some experimental tests of the present disclosure.

FIG. 8 shows graphs of surface temperature distribution of a pot with a coating structure of the embodiment that is heated to a temperature of 200° C., in accordance with some experimental tests of the present disclosure.

### DETAILED DESCRIPTION

The following description provides various embodiments, or examples, for implementing different features of the present disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numbers and/or letters in the various examples. This repetition is for the purpose of simplicity and clarity and does not in itself dictate a relationship between the various embodiments and/or configurations discussed. In addition, the accompanying drawings may only depict portions of material layers or devices related to the present disclosure.

Embodiments of the present disclosure provide a composite coating layer and a coating structure that includes the composite coating layer. Embodiments of the present disclosure further provide a heating device that includes a composite coating layer of the embodiments. According to the embodiments, the composite coating layer is formed by thermal spraying. During the thermal spraying process, one of more metal materials of the composite coating layer, which has a lower melting point and is in the liquid state, may flow to fill pores and/or seams in the coating layer, thereby forming a denser coating structure. In addition, the combinations of any two or more of the selected materials that have different melting points will form a rough surface of the composite coating layer after the thermal spraying process is performed. The rough surface of the composite coating layer has no specific shape. Therefore, the composite coating layer has nonstick, abrasion resistant and corrosion resistant properties, in accordance with some embodiments of the present disclosure. In addition, when the composite coating layer of the embodiments is applied to a heating device, for example, as a coating for various cooking utensils such as woks and frying pans that cook food, the heating device lasts a longer service life due to the nonstick, abrasion resistant and corrosion resistant properties of the composite coating layer. Besides, the heating device that includes the composite coating layer of the embodiments has advantages of rapid heat conduction and uniform dispersion of heat energy during heating.

A method of forming a coating structure includes providing a substrate and forming a composite coating layer on the substrate, in accordance with some embodiments of the present disclosure. The aforementioned substrate may include a metal material or a ceramic material. Metal material that can be used as the substrate material includes (but is not limited to) iron, aluminum, aluminum alloy, stainless steel or carbon steel. Ceramic material that can be used as the substrate material includes (but is not limited to) quartz or ordinary glass. In addition, the substrate of the embodiments is not limited to any geometric shape.

In some embodiments, the aforementioned composite coating layer includes metallic materials and ceramic materials, and can be formed in the following manner. For example, a mixture that includes several kinds of metal powders and one or more kinds of ceramic powders is first formed. Next, the metal powders and ceramic powders in the mixture melt and form a molten mixture. The molten mixture is then sprayed onto a surface of the substrate to form a composite coating layer.

In some embodiments, the aforementioned materials such as metal powders and ceramic powders can be melted by a thermal spray coating method to form a molten mixed material. The aforementioned thermal spray coating method includes, for example, plasma thermal spraying, flame thermal spraying, high-speed flame thermal spraying, atmospheric plasma spraying, or a combination of the foregoing methods. Next, the aforementioned molten mixed material is spray-coated on a surface of the substrate by, for example, a thermal spray coating method to form a composite coating layer. According to some embodiments, the composite coating can be sprayed back and forth several times on the surface of the substrate to achieve a predetermined thickness of the composite coating layer. For example, the thickness of the composite coating layer is in (but not limited to) a range of about 50 μm to about 150 μm, and can be determined and adjusted depending on application requirements.

In addition, when the high temperature molten mixed material (that includes molten metal materials and molten ceramic materials) is sprayed onto the surface of the substrate, the high temperature molten mixed material that is in contact with the substrate can be cooled and solidified since the substrate has a relatively cool surface. In some embodiments, the composite coating layer includes several elements that have different melting points, and the combinations of any two or more elements in the composite coating layer will form protrusions that have non-specific sizes and irregular shapes on the surface of the coating layer after solidification. When the next layer of high temperature molten mixed material is sprayed onto the previously formed layer of lower-temperature solidified material, the high temperature molten mixed material will partially or completely melt the underlying portion of the solidified material to form new mixed portions. Then, the new mixed portions will be solidified to re-form protrusions that have non-specific shapes and varying bump degrees on the surface of the coating layer. After thermal spraying layer by layer, the composite coating is formed, and can be collectively referred to as a composite coating layer. During the thermal spraying process, metals with lower melting points melt and change state from solid to liquid, and the melted metals fill the pores and/or seams in the coating layer. Therefore, the composite coating layer of the embodiments has denser characteristics. According to the aforementioned descriptions, the composite coating layer includes elements that have different melting points. After thermal spraying and solidification, random combinations of the elements form protrusions with non-specific shapes, which lead to a rough surface of the composite coating layer. That is, the surface of the composite coating layer may have different roughness levels at different locations, in accordance with some embodiments of the present disclosure. In some embodiments, the surface of the composite coating layer has a surface roughness of at least 1 μm. For example, the surface roughness of the composite coating layer is in a range of 1 μm to 50 μm, and preferably 3 μm to 4.5 μm.

The following provides descriptions of a coating structure in accordance with some embodiments of the present disclosure with references made to the accompanying drawings.

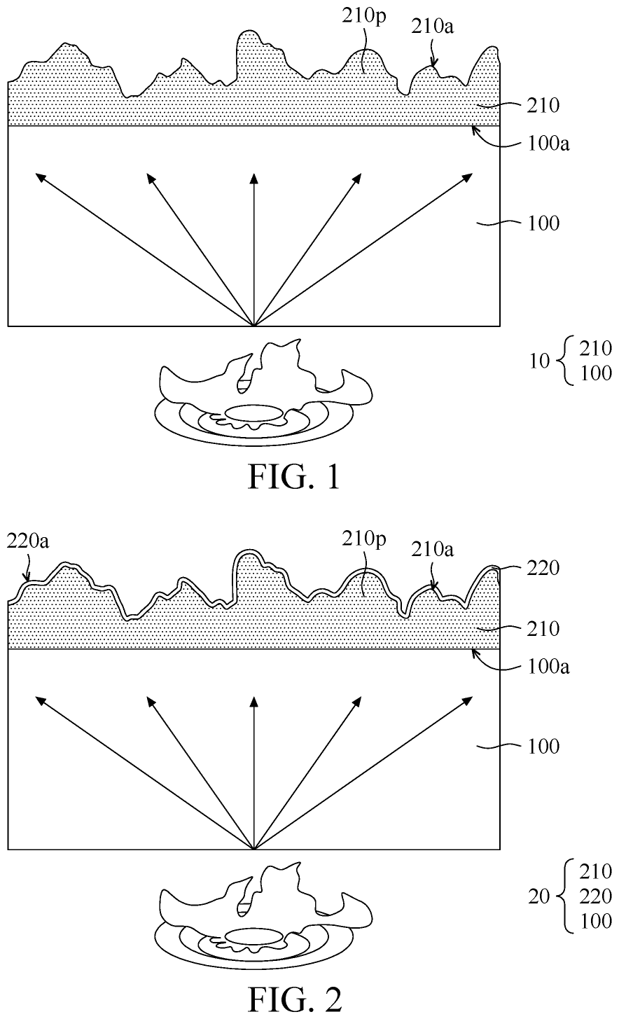

FIG. 1 is a schematic cross-sectional view of a coating structure 10, in accordance with some embodiments of the present disclosure. In this exemplary embodiment, a substrate 100 is provided, and a composite coating layer 210 is formed on the first surface 100a of the substrate 100. The first surface 100a of the substrate 100 is, for example, an inner surface of a heating device (such as a pot). The first surface 100a of the substrate 100 can be a flat surface, a curved surface, a surface with another shape, or a surface having a combination of the foregoing shapes. However, the present disclosure is not limited thereto. In addition, the composite coating layer 210 can be formed by the aforementioned steps, such as forming a molten mixture (for example, including molten metal materials and molten ceramic materials) and spraying the molten mixture (for example, including alloy melting and solidification). The resulting composite coating layer 210 of some embodiments has a rough surface 210a.

As shown in FIG. 1, in some embodiments, several protrusions 210P that have non-specific shapes and varying bump degrees are formed on the surface of the composite coating layer 210, so that the composite coating layer 210 has the rough surface 210a with different levels of surface undulations. The surface 210a of the composite coating layer 210 may have a surface roughness of at least 1 μm. For example, the surface 210a of the composite coating layer 210 may have a surface roughness in a range of about 1 μm to about 50 μm, and preferably in a range of about 3 μm to about 4.5 μm.

In addition, according to the embodiments, the surface 210a of the composite coating layer 210 includes several protrusions 210P that are randomly distributed and have different sizes, as shown in FIG. 1. The composite coating layer 21 has a rough surface of non-specific shape. When a fire source that is under the substrate 100 provides heat energy, the heat energy can be rapidly conducted to the first surface 100a of the substrate 100, and then evenly dispersed in many different directions that are provided by the rough surface of the composite coating layer 210. Therefore, when the composite coating layer 210 of the embodiment is applied to a heating device, the heating device can have a good heat distribution effect. Compared to a heating device that includes a traditional coating layer having a substantially flat surface, which has poor heat distribution effect, the heating device that includes the composite coating layer 210 of the embodiment does have an improved heat distribution effect (i.e. the thermal uniformity of pot surface is increased). According to some experimental results, at an oil temperature of 100° C., the composite coating layer 210 of the embodiment can improve the thermal uniformity of pot surface to approximately 81.7%.

In addition, although the coating structure 10 of the above-mentioned example only includes the composite coating layer 210, the present disclosure is not limited thereto. The coating structure 10 may also include one or more layers of other material layers that are formed above or below the composite coating layer 210.

FIG. 2 is a schematic cross-sectional view of another coating structure 20, in accordance with some embodiments of the present disclosure. In this exemplary embodiment, the coating structure 20 includes a composite coating layer 210 on the substrate 100 and a sealing layer 220 on the composite coating layer 210. The sealing layer 220 protects the underlying composite coating layer 210. The sealing layer 220 is conformally formed on the surface 210a of the composite coating layer 210 as a blanket. In some embodiments, the sealing layer 220 includes one or more polymer materials, such as Teflon, silicone oil, or another suitable material.

In some embodiments, the sealing layer 220 may partially penetrate into the pores and/or seams of the composite coating layer 210 below. When the cross-section of the coating structure 20 is observed by a scanning electron microscope, it can still be seen that the sealing layer 220 clearly exists.

In addition, it should be noted that the sealing layer 220 of the embodiment generally undulates compliantly along the rough surface 210a of the composite coating layer 210, so that the surface 220a of the sealing layer 220 also has an undulating rough surface. In some embodiments, the surface 220a of the sealing layer 220 has a surface roughness in a range of about 1 μm to about 50 μm, and preferably in a range of about 3 μm to about 4.5 μm.

In addition, in some embodiments, the composite coating layer 210 has a thickness ranging from 50 μm to 150 μm, and the sealing layer 220 has a thickness ranging from 10 μm to 500 μm. Preferably, the sealing layer 220 of the embodiment has a sufficient thickness and is capable of covering the protrusions 210P of the composite coating layer 210 below. However, the sealing layer 220 should not be too thick to form a rough surface with undulations. In some exemplary embodiments, the composite coating 210 has a thickness of about 50 μm to about 70 μm, and the sealing layer 220 has the thickness of about 60 μm. However, it should be noted that the numerical values of the thicknesses are provided for illustrative purposes, and the embodiments of the present disclosure are not limited thereto.

Accordingly, similar to the embodiment shown in FIG. 1, when the coating structure 20 shown in FIG. 2 is applied to a heating device, both of the rough surface 210a of the composite coating layer 210 and the rough surface 220a of the sealing layer 220 can improve the thermal uniformity of the heating device.

In addition, in some traditional heating devices, a coating layer is formed to seal the pores in the substrate material, and the coating layer generally provides an oleophobic surface on the surface of the substrate, so that the oil cannot be dispersed evenly to form a continuous oil film. Compared to the coating layer in the traditional heating devices, the rough surface 210a of the composite coating layer 210 or the rough surface 220a of the sealing layer 220 of the embodiment can disperse the oil thereon more evenly and form a continuous oil film.

In some embodiments, the composite coating layer 210 includes metal materials and ceramic materials, and can be formed by the method described above. For example, the composite coating layer 210 can be formed by providing mixed powder raw materials (for example, including metal material powders and ceramic material powders), melting the mixed powder raw materials, spraying the molten mixture and the solidification reaction. Accordingly, the composite coating 210 that has a rough surface with protrusions of non-specific shapes can be formed, in accordance with some embodiments of the present disclosure.

The aforementioned mixed powder raw materials include, for example (but are not limited to) metal oxides. In some embodiments, the mixed powder raw materials include titanium-containing oxide, zirconium-containing oxide, nickel-containing oxide, or a combination of the foregoing metal oxides.

In some embodiments, when the mixed powder raw materials are observed by a scanning electron microscope that has secondary electron detector, the image shows that most of the mixed powder raw materials have a spherical surface morphology, and a few of the mixed powder raw materials have irregular rod-shaped surface morphologies. In some embodiments, the mixed powder raw materials include (but are not limited to) spherical micro-structures that have a particle size ranging from about 10 micrometers (μm) to about 60 micrometers (μm).

In some embodiments, the raw materials include TiO2 and one or more quasicrystalline materials with high mechanical strength, thermal stability and low friction coefficient. The composite coating layer that is formed from a combination of TiO2 and a quasicrystalline material has advantages of good thermal stability, lightweight and hydrophobic properties. During a plasma spraying process, metals with lower melting points melt and turn into a liquid or a semi-liquid form to fill the pores and/or seams in the coating layer. Therefore, a denser coating structure can be formed. In addition, random combinations of the elements in the raw materials that have different melting points would form protrusions that have irregular sizes and non-specific shapes on the surface of the composite coating layer. In some embodiments, the surface roughness of the composite coating layer is in a range of 1 μm to 50 μm. Preferably, a centerline average roughness (Ra) is, for example, in a range of 3 μm to 4.5 μm.

The preparation methods of exemplary but non-limiting mixed powders are provided below. The mixed powders as prepared in the following descriptions can be referred to as powder mixture I, powder mixture II and powder mixture III.

40 parts by weight of TiO2, 6.8 parts by weight of zirconium, 51 parts by weight of nickel and 3 parts by weight of aluminum were mixed and then sprayed to form powders by air spraying, thereby forming a powder mixture I.

67 parts by weight of TiO2, 6.8 parts by weight of zirconium, 25 parts by weight of nickel and 1.3 parts by weight of aluminum were mixed and then sprayed to form powders by air spraying, thereby forming a powder mixture II.

87 parts by weight of TiO2, 2.6 parts by weight of zirconium, 9.8 parts by weight of nickel and 0.5 parts by weight of aluminum were mixed and then sprayed to form powders by air spraying, thereby forming a powder mixture III.

In some embodiments, after the powder mixture (that includes aforementioned mixed powder raw materials) is sprayed on a substrate (such as an aluminum substrate) by a plasma spray process to form a composite coating layer, the composite coating layer may include titanium (Ti), zirconium (Zr), nickel (Ni) and oxygen (O). The composite coating layer may also include carbon (C) during the spraying process. In addition, according to some experiments and test results, the proportions of each component of the composite coating layer of the embodiments, especially the proportions of titanium, zirconium, nickel and oxygen, are related to the abrasion resistance of the composite coating layer.

According to some embodiments of the present disclosure, if the total weight of the composite coating layer is 100 wt %, the composite coating layer may include 4.3 wt % to 7.6 wt % carbon (C), 9.5 wt % to 21.8 wt % oxygen (O), 1.2 wt % to 3.5 wt % aluminum (Al), 23.5 wt % to 42.6 wt % titanium (Ti), 16.8 wt % to 41 wt % nickel (Ni) and 14.3 wt % to 23.7 wt % zirconium (Zr), based on the total weight of the composite coating layer.

The elemental composition analysis of the composite coating layer of some experimental examples and comparative examples are provided below.

Please refer to Table 1. The raw materials of the powder mixture I were melted and sprayed on a test piece to form a composite coating layer, and different positions of the composite coating layer were sampled and analyzed. Example 1 to Example 6 in Table 1 show the weight percentages of carbon (C), oxygen (O), aluminum (Al), titanium (Ti), nickel (Ni) and zirconium (Zr) at six different positions of the composite coating layer, based on the total weight of the composite coating layer (100 wt %).

TABLE 1

| | Exam- | Exam- | Exam- | Exam- | Exam- | Exam- |
|---|---|---|---|---|---|---|
| | ple 1 | ple 2 | ple 3 | ple 4 | ple 5 | ple 6 |
| Element | (wt %) | (wt %) | (wt %) | (wt %) | (wt %) | (wt %) |
| Carbon (C) | 4.77 | 5.15 | 5.67 | 5.05 | 5.92 | 7.59 |
| Oxygen (O) | 10.01 | 11.41 | 11.72 | 13.50 | 21.79 | 16.79 |
| Aluminum (Al) | 1.24 | 1.48 | 2.58 | 1.81 | 1.61 | 2.37 |
| Titanium (Ti) | 35.27 | 39.01 | 36.34 | 42.59 | 33.06 | 23.51 |
| Nickel (Ni) | 28.30 | 19.30 | 20.84 | 16.83 | 41.35 | 35.42 |
| Zirconium (Zr) | 20.41 | 23.65 | 22.85 | 20.22 | 16.65 | 14.32 |

Please refer to Table 2. The raw materials of the powder mixture I were melted and sprayed on a substrate of a pot to form a composite coating layer, and several positions of the composite coating layer were sampled and analyzed. Example 7 to Example 10 in Table 2 show the weight percentages of carbon (C), oxygen (O), aluminum (Al), titanium (Ti), nickel (Ni) and zirconium (Zr) at four different positions of the composite coating layer, based on the total weight of the composite coating layer (100 wt %).

TABLE 2

| | Example 7 | Example 8 | Example 9 | Example 10 |
|---|---|---|---|---|
| Element | (wt %) | (wt %) | (wt %) | (wt %) |
| Carbon (C) | 4.33 | 4.49 | 4.72 | 4.64 |
| Oxygen (O) | 9.76 | 12.37 | 10.19 | 10.91 |
| Aluminum (Al) | 2.58 | 2.17 | 3.02 | 2.23 |
| Titanium (Ti) | 29.67 | 35.69 | 28.96 | 32.86 |
| Nickel (Ni) | 37.36 | 29.75 | 37.64 | 34.34 |
| Zirconium (Zr) | 16.30 | 15.53 | 15.47 | 15.02 |

According to Examples 1-6 in Table 1 and Examples 7-10 in Table 2, the elemental composition results of each sampling position show that the content of each of the elements is substantially within the range of the composite coating layer of the embodiments.

Please refer to Table 3. The raw materials of the powder mixture II were melted and sprayed on a substrate of a pot to form another composite coating layer, and several positions of this composite coating layer were sampled and analyzed. Comparative Example 1 to Comparative Example 4 in Table 3 show the weight percentages of carbon (C), oxygen (O), aluminum (Al), titanium (Ti), nickel (Ni) and zirconium (Zr) at four different positions of the composite coating layer, based on the total weight of the composite coating layer (100 wt %).

TABLE 3

| | Comparative | Comparative | Comparative | Comparative |
|---|---|---|---|---|
| | Example 1 | Example 2 | Example 3 | Example 4 |
| Element | (wt %) | (wt %) | (wt %) | (wt %) |
| Carbon (C) | 3.40 | 3.13 | 3.49 | 3.69 |
| Oxygen (O) | 23.42 | 24.65 | 24.88 | 22.77 |
| Aluminum (Al) | 0.48 | 0.57 | 0.61 | 0.54 |
| Titanium (Ti) | 50.21 | 51.07 | 50.44 | 49.43 |
| Nickel (Ni) | 9.06 | 10.16 | 9.62 | 9.75 |
| Zirconium (Zr) | 13.43 | 10.42 | 10.96 | 13.82 |

Please refer to Table 4. The raw materials of the powder mixture III were melted and sprayed on a substrate of a pot to form another composite coating layer, and several positions of this composite coating layer were sampled and analyzed. Comparative Example 5 to Comparative Example 9 in Table 4 show the weight percentages of carbon (C), oxygen (O), aluminum (Al), titanium (Ti), nickel (Ni) and zirconium (Zr) at four different positions of the composite coating layer, based on the total weight of the composite coating layer (100 wt %).

TABLE 4

| | Comparative | Comparative | Comparative | Comparative | Comparative |
|---|---|---|---|---|---|
| | Example 5 | Example 6 | Example 7 | Example 8 | Example 9 |
| Element | (wt %) | (wt %) | (wt %) | (wt %) | (wt %) |
| Carbon (C) | 3.48 | 3.04 | 2.86 | 3.00 | 2.79 |
| Oxygen (O) | 25.14 | 26.33 | 26.60 | 25.57 | 27.62 |
| Aluminum (Al) | 0.36 | 0.40 | 0.17 | 0.54 | 0.18 |
| Titanium (Ti) | 56.32 | 57.48 | 58.66 | 56.40 | 58.83 |
| Nickel (Ni) | 4.33 | 4.97 | 2.83 | 6.81 | 2.82 |
| Zirconium (Zr) | 10.37 | 7.78 | 8.89 | 7.68 | 7.75 |

According to the experimental results above, each sample taken from the composite coating layer that is formed by melting and spraying the raw materials of powder mixture II contains several elements that are outside the content ranges of the embodied composite coating layer. For example, the results of each sampling position in Comparative Example 1 to Comparative Example 4 of Table 3 show that the contents of oxygen (such as 22.77 wt % to 24.88 wt %), titanium (such as 49.43 wt % to 51.07 wt %) and nickel (such as 9.06 wt % to 10.16 wt %) are outside the content ranges of oxygen, titanium and nickel of the composite coating layer of the embodiments. In addition, several elements of each sample that is taken from the composite coating layer formed by melting and spraying the raw materials of powder mixture III are also outside the content ranges of the embodied composite coating layer. For example, the results of each sampling position in Comparative Example 5 to Comparative Example 9 of Table 4 show that the contents of oxygen (such as 25.14 wt % to 27.62 wt %), titanium (such as 56.32 wt % to 58.83 wt %) and nickel (such as 2.82 wt % to 6.81 wt %) are outside the content ranges of oxygen, titanium and nickel of the composite coating layer of the embodiments. Accordingly, a composite coating layer of the embodiments, which contains related elements in the specific content ranges, can be obtained by melting initial materials (such as, but not limited to, powder mixture I) containing appropriate ceramic materials. According to experimental results (e.g., the detailed descriptions in the following contents), the composite coating layer that contains related elements in the specific content ranges of the embodiments have several excellent properties, such as sufficient hardness, good abrasion resistance and good adhesive strength, as well as high thermal uniformity and rapid heat conduction to reach thermal uniformity.

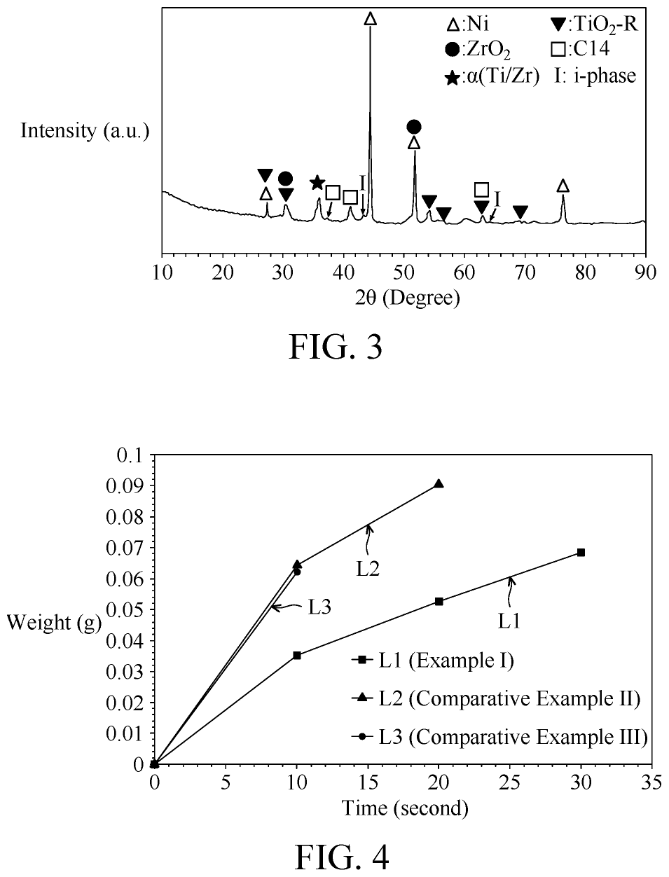

In addition, non-destructive analyzes, such as phase composition and crystal structure obtained by X-ray diffraction (XRD) analysis, were performed on the composite coating layers that were formed by melting and spraying as described above. FIG. 3 is an X-ray diffraction pattern of a composite coating layer, in accordance with some embodiments of the present disclosure. FIG. 3 shows the corresponding peak intensity (a.u.) of different materials at the diffraction peak position (diffraction angle 2Θ). For example, the XRD results of a composite coating layer that is formed by melting and spraying the raw material of powder mixture I show that the composite coating layer of the embodiment has a quasicrystalline (QC) phase, such as an icosahedral quasicrystalline phase (i-phase).

In addition, according to the XRD results, the composite coating layer of the embodiments also includes ceramic oxide, such as zirconium oxide (ZrO2). In some embodiments, according to XRD results, the composite coating layer of the embodiments also has an intermetallic compound phase, such as a Laves phase. In some embodiments, according to XRD results, the composite coating layer also has a stable alloy phase, such as an a (titanium/nickel) phase. That is, the composite coating layer of some embodiments can form a composite oxide ceramic phase composed of metal and ceramic. In addition, if the cross-sections of the composite coating layers of some embodiments are observed by a metallographic microscope (i.e. an optical microscope; OM), the image shows that darker blue portions of oxide ceramics alternately with brighter portions of alloy. The composite coating layer alternated oxide ceramics with alloy provides nonstick coating property, in accordance with some embodiments of the present disclosure. Therefore, according to XRD results as shown in FIG, 3 and cross-section observation of the composite coating layer by an metallographic microscope, the powder mixture of the embodiment is thermally sprayed to form a coating in a semi-molten phase or a molten phase that may include Ni-based alloy phase, C14 intermetallic compound and ceramic phase. The coating is then transformed into the quasicrystalline (QC) phase.

In addition, according to some embodiments, when the composite coating layer is prepare by melting and spraying, the coating will be sprayed back and forth several times on the surface of the substrate to make the composite coating layer reach a predetermined thickness. The coating portions that have been sprayed on the surface of the substrate may be repeatedly heated due to the back and forth spraying at a high temperature, causing them to oxidize and thereby generating new quasicrystals. Therefore, besides that the combinations of any two or more elements in the composite coating layer of the embodiments will form protrusions on the rough surface as described above, the formation of quasicrystals is also beneficial to the roughness of the nonspecific shaped surface of the composite coating layer.

In addition, the composite coating layers of some embodiments were analyzed by a hardness test, such as a micro-Vickers hardness test. In some embodiments, the micro-Vickers hardness of the composite coating layers is 519 to 611 HV0.1. The results indicate that the quasicrystalline (QC) structures can make the composite coating layers of the embodiments have high hardness. It should be noted that, unlike the single quasicrystalline (QC) layer in conventional technologies, the composite coating layer of the embodiments does not contain a single QC structure phase, and does not contain an excessively high proportion of the QC structure phases. For example, the QC structure phase of the composite coating layer of the embodiments is not greater than 50 wt % of the composite coating layer. In some embodiments, the QC structure phase is present in the composite coating layer in a range of about 10 wt % to about 40 wt %. In some embodiments, the QC structure phase is present in the composite coating layer in a range of about 20 wt % to about 25 wt %.

Several coating structures with composite coating layers of exemplary embodiments and comparative examples are described below, so that the features and advantages of the embodiments may be more obvious and understandable. The performance tests, such as boiling test, abrasion test, surface temperature distribution detection and some other performance tests, were conducted to analyze and evaluate the composite coating layers of the embodiments and comparative examples.

### Boiling Test

In the boiling test, a commercial pure aluminum alloy pot, a commercial pure stainless steel alloy pot and a commercial pure aluminum alloy pot that was coated with pure Teflon were selected. In addition, a pot with a composite coating layer of the embodiments and the pots with the composite coating layers of the comparative examples were selected for the boiling test. To reduce the experimental variability, those pots have similar dimensions, including similar shapes and bottom areas. In the boiling test, for example, the raw materials of powder mixture I were melted and sprayed on an aluminum pot (i.e., an aluminum substrate was provided) to form the composite coating layer of the embodiments, and the boiling test was performed on the composite coating layer on the Al pot.

In addition, details of the rough surface of the composite coating layer of the embodiments are similar to the above-mentioned descriptions of the rough surface 21a of the composite coating layer 21 in FIG. 1, and will not be repeated here.

In the boiling test, clean water was poured into these pots and heated. When water was heated to approximately 100° C., the bubbles in the water were observed to evaluate the heat conduction of these pots. During boiling test, the center of the pot was generally above the heat source, which was the hottest position of the entire pot.

According to experimental results, after heating water in the pure aluminum alloy pot, the bubbles generated were mostly concentrated near the center of the pot bottom. However, after heating water in the pot coated with the composite coating layer of the embodiment, the bubbles generated were evenly distributed over the entire surface of the bottom of the pot, and not merely concentrated near the center of the pot. Therefore, the composite coating layer of the embodiment can evenly conduct the heat from the substrate of the pot to the rough top surface of the composite coating layer, thereby improving the thermal uniformity of the pot surface (i.e. provided by the rough top surface of the composite coating layer).

### Abrasion Test

In the abrasion test, the raw materials of powder mixture I, powder mixture II and powder mixture III were melted and sprayed on the substrates (such as aluminum substrates) through plasma spraying to form the composite coating layers. The abrasion tests were performed on these composite coating layers.

In the abrasion test, these composite coating layers were subjected to abrasion experiments using ASTM G65 standard test method, which is also known as dry sand abrasion test. To simplify the description, the dry sand abrasion test may also be referred to as abrasion test below. A specific weight was applied to each composite coating layer in the experiments for rubbing the sample surface, and the weight loss of each composite coating layer at different rubbing times was measured and recorded (based on the initial weight of the composite coating layer).

It should be noted that the dry sand abrasion test is one of performance tests on the composite coating layer, rather than a step of the process for preparing the composite coating layer. The abrasion resistance is also used to present the ability of a coating material surface to withstand the effects of rubbing over time.

FIG. 4 shows graphs of weight loss of each of the composite coating layers at different rubbing times in some of the dry sand abrasion tests according to the present disclosure. In FIG. 4, graph L1 represents the weight loss (grams) of an embodied sample of the composite coating layer that was made from the raw materials of powder mixture I (hereinafter also referred to as the composite coating layer of Example I) at different rubbing times. In FIG. 4, graph L2 represents the weight loss (grams) of a comparative sample of the composite coating layer that was made from the raw materials of powder mixture II (hereinafter also referred to as the composite coating layer of Comparative Example II) at different rubbing times. In FIG. 4, graph L3 represents the weight loss (grams) of another comparative sample of the composite coating layer that was made from the raw materials of powder mixture III (hereinafter also referred to as the composite coating layer of Comparative Example III) at different rubbing times. The results show that the composite coating layer of Example I lost the least weight under the same abrasion time.

For example, the composite coating layer of Comparative Example II (graph L2) lost weight of about 0.0643 grams after rubbing for 10 seconds, and lost weight of about 0.0905 grams after rubbing for 20 seconds. The substrate was exposed after the composite coating layer of Comparative Example II was rubbing for 20 seconds. The composite coating layer of Comparative Example III (graph L3) lost about 0.0621 grams of weight after rubbing for 10 seconds, and the substrate was exposed at this time. However, the composite coating layer of Example I (graph L1) lost about 0.02177 grams after rubbing for 10 seconds, lost about 0.04386 grams after rubbing for 20 seconds, and lost about 0.05652 grams after rubbing for 30 seconds. The substrate was exposed after the composite coating layer of Example I was rubbing for 30 seconds. According to the abrasion results, after rubbing for 10 seconds, the weight loss of the composite coating layer of Example I (i.e. an embodied composite coating layer) is only about 0.33 times the weight loss of the composite coating layer of Comparative Example II.

Therefore, according to the abrasion test results, the composite coating layer of the embodiment, such as the composite coating layer of Example 1 (graph L1 in FIG. 4) prepared from the raw materials of powder mixture 1, has better performance of abrasion resistance. That is, a pod coated with the composite coating layer of the embodiment presents has good abrasion resistance.

It should be noted that in the initial mixed powder raw materials for prepare each of the composite coating layers in the abrasion test, the metal oxide content of powder mixture I (i.e., for forming the composite coating layer of the embodiment) is less than the metal oxide content of powder mixture II. The metal oxide content of powder mixture II is less than the metal oxide content of the mixed powder III. The metal oxide is, for example, a titanium-containing oxide (such as titanium dioxide), a zirconium-containing oxide, a nickel-containing oxide, or a combination of the foregoing metal oxides.

In addition, in the initial mixed powder raw materials for preparing each of the composite coating layers in the abrasion test, the ceramic material content of powder mixture III is greater than the ceramic material content of powder mixture II. The ceramic material content of powder mixture II is greater than the ceramic material content of powder mixture I (i.e., for forming the composite coating layer of the embodiment).

Therefore, the experimental results have indicated that changes in the mixed powder raw materials will affect the composition ratio of the composite coating layer, and may affect the content of the generated quasicrystalline structures, thereby affecting the abrasion resistance performance of the composite coating layer.

In addition, before performing the abrasion test, the composite coating layer of Example 1 (for example, prepared from the raw materials of powder mixture I) was observed by an electron microscope, and the thickness of the composite coating layer of Example 1 was in a range of about 50 μm and about 70 μm. In addition, the hardness of the composite coating layer that was evaluated by a micro-Vickers hardness test was in a range of approximately 519 to approximately 611. In addition, the porosity of the composite coating layer of Example I was approximately 1.0%±0.3%. However, the aforementioned numerical values are provided for illustrative purposes, and the embodiments of the present disclosure are not limited thereto.

In addition, the composite coating layer of Example I was tested by the ASTM C633 standard test method to detect its adhesion on the substrate. The bonding strength of the composite coating layer of Example I was approximately 9200 Psi.

In addition, before and after the abrasion test, the rubbing surface of the composite coating layer of Example I was also observed by a scanning electron microscope (SEM). The SEM results show that less end portions of the quasicrystals are exposed before rubbing, and more end portions of the quasicrystals are exposed after rubbing. Thus, the composite coating layer of the embodiment does have quasicrystalline structures, and more quasicrystals appear after rubbing. This observation results also correlate with the results of the abrasion test. According to the weight loss results in the abrasion test, the more the quasicrystalline structures of the composite coating layer of the embodiment are exposed, the better the abrasion resistant properties of the composite coating layer has. Thus, the composite coating layer of the embodiment has less weight loss under the same abrasion time (e.g., FIG. 4). Therefore, the composite coating layer of the embodiment has high hardness and good abrasion resistance due to the presence of the quasicrystalline structures.

### Detection of Surface Temperature Distribution

In the detection of surface temperature distribution, a commercial stainless steel pot, a commercial pure aluminum alloy pot, a commercial pots with conventional nonstick coating and a pots with a coating structure of the embodiment are used in the experiments of temperature detection.

To reduce experimental variability, those pots have similar dimensions, including similar shapes and bottom areas. Among them, the selected pot with conventional nonstick coating includes a Teflon layer that is coated on an aluminum pot (that is, an aluminum substrate is provided). In addition, in this experiment, the raw material of powder mixture I was sprayed on an aluminum pot to form the composite coating layer of the embodiment, and a sealing layer was formed on the composite coating layer to obtain a coating structure of the embodiment. Details of the composite coating layer and the sealing layer of the embodiment are similar to the above-mentioned descriptions of the composite coating layer 210 and the sealing layer 220 in FIG. 2, and will not be repeated here. In addition, in the pot with the coating structure of the embodiment, a Teflon layer is used as the sealing layer that is conformally formed on the top of the composite coating layer.

In the surface temperature distribution detection, these pots were empty and heated to a temperature of 200° C. Then, the heat source is turned off, and the surface temperature changes with time were measured at three locations of each pot. That is, the temperatures of the rim, the bottom edge and the bottom center of each pot were measured with time to evaluate the surface temperature distribution. The rim of the pot refers to the raised edge of the pot. According to the experimental results, the degree of thermal uniformity of the pot can also be obtained (expressed as a percentage), and the definition will be described later.

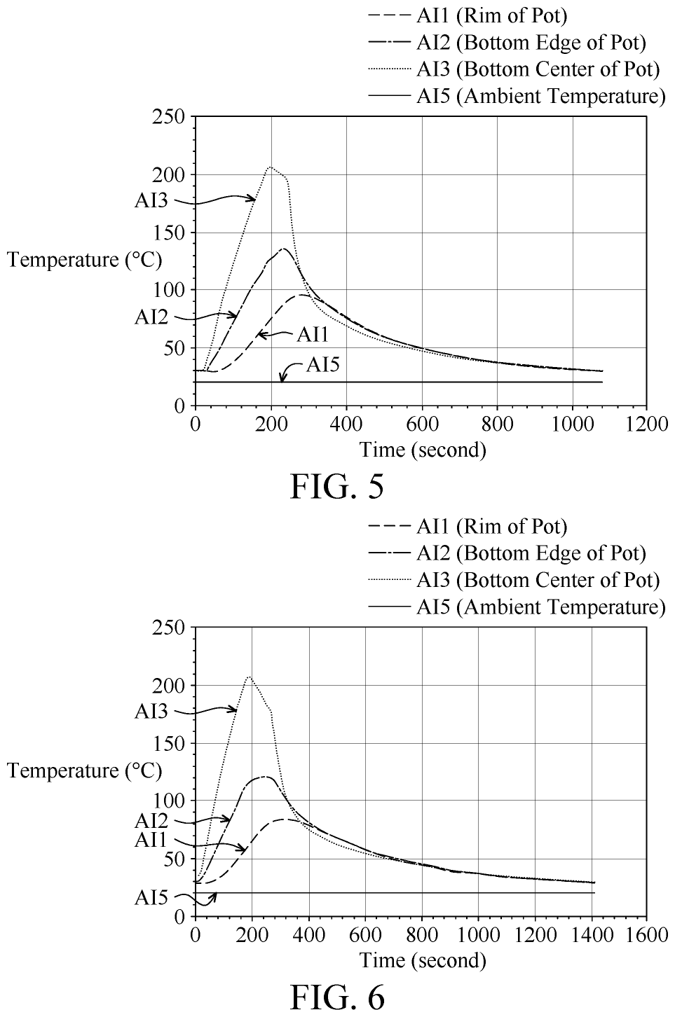

FIG. 5 shows graphs of surface temperature distribution of a commercial stainless steel pot that is heated to a temperature of 200° C., in accordance with some experimental tests of the present disclosure.

FIG. 6 shows graphs of surface temperature distribution of a commercial pure aluminum alloy pot that is heated to a temperature of 200° C., in accordance with some experimental tests of the present disclosure.

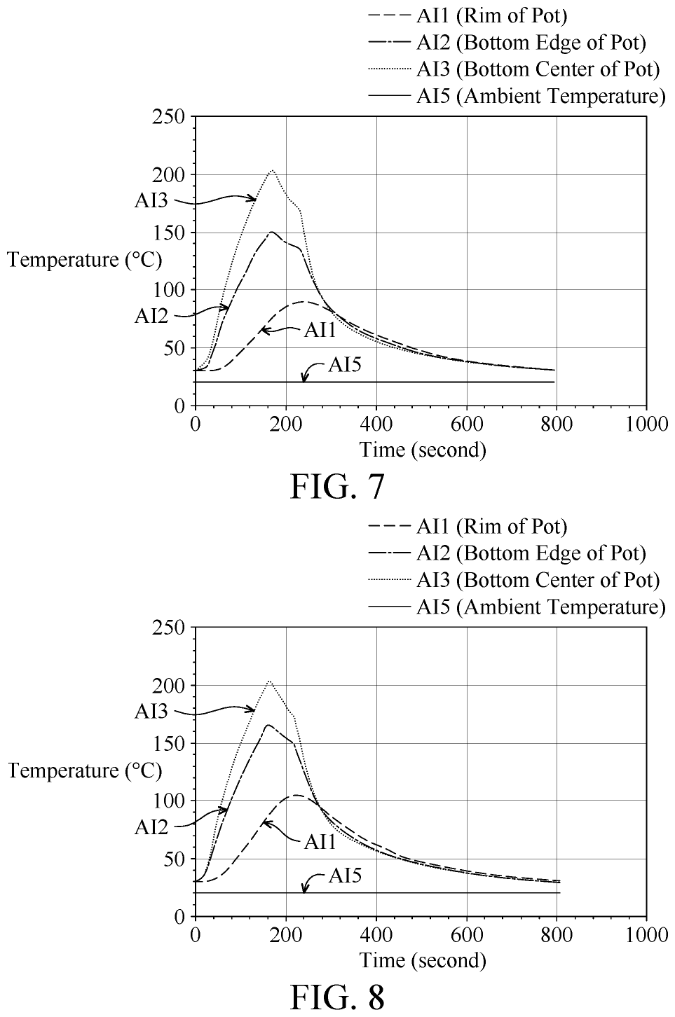

FIG. 7 shows graphs of surface temperature distribution of a commercial nonstick pot with conventional nonstick coating that is heated to a temperature of 200° C., in accordance with some experimental tests of the present disclosure.

FIG. 8 shows graphs of surface temperature distribution of a pot with a coating structure of the embodiment that is heated to a temperature of 200° C., in accordance with some experimental tests of the present disclosure.

In addition, in FIG. 5-FIG. 8, graph AI1 represents a temperature distribution graph of the rim of the pot, graph AI2 represents a temperature distribution graph of the bottom edge of the pot, graph AI3 represents a temperature distribution graph of the bottom center of the pot, and graph AI5 represents an ambient temperature distribution curve.

During detection of surface temperature distribution, the bottom center of the pot is closest to the heat source (e.g., a fire source) (generally directly above the heat source; that is, the bottom center of the pot is the place of the highest temperature of the entire pot). The bottom edge of the pot is farther from the heat source than the bottom center of the pot, but closer to the heat source than the rim of the pot. The rim of the pot is the furthest from the heat source. Therefore, the maximum temperature of the bottom center temperature of the pot (referring to graph AI3) is greater than the maximum temperature of the bottom edge temperature of the pot (referring to graph AI2). The maximum temperature of the bottom edge temperature of the pot (referring to graph AI2) is greater than the maximum temperature of the rim temperature of the pot (referring to graph AI1).

According to the experimental results in FIG. 5, the analysis of surface temperature distribution of the stainless steel pot is provided below.

As shown in graph AI3 of FIG. 5, when the stainless steel pot is heated to a temperature of 200° C., the temperature at the bottom center of the pot continues to increase until reaching its highest temperature (about 205.6° C.) after about 195 seconds. The temperature then gradually decreases.

As shown in graph AI2 of FIG. 5, the temperature of the bottom edge of the stainless steel pot reaches its maximum temperature (about 134.2° C.) after about 236 seconds. The temperature then gradually decreases.

As shown in graph AI2 of FIG. 5, the temperature of the rim of the stainless steel pot reaches its maximum temperature (about 95.6° C.) after about 290 seconds. The temperature then gradually decreases.

When the temperature detection is performed on the stainless steel pot, the ambient temperature is constantly maintained at about 20° C., as shown in graph AI5 of FIG. 5.

In addition, as shown in graph AI3 and graph AI2 of FIG. 5, when the stainless steel pot is heated to a temperature of 200° C., the temperature difference between the maximum temperature at the bottom center of the pot and the maximum temperature at the bottom edge of the pot is about 71.4° C.

According to the experimental results above, the degree of thermal uniformity of the stainless steel pot can be calculated using formula (1) below.

$$Thermal uniformity ( \% ) = 100 \% - [ ( the highest temperature at the bottom center of the pot - the highest temperature at the bottom edge of the pot ) / the highest temperature at the bottom center of the pot ] * 100 \% \qquad ( 1 )$$

Therefore, the degree of thermal uniformity of the stainless steel pot that is heated to a temperature of 200° C. is calculated as below:

$$100 \% - [ ( 205.6 - 134.2 ) / 205.6 ] * 100 \% = 65 \%$$

According to the experimental results in FIG. 6, the analysis of surface temperature distribution of the pure aluminum alloy pot is provided below.

As shown in graph AI3 of FIG. 6, when the pure aluminum alloy pot is heated to a temperature of 200° C., the temperature at the bottom center of the pot continues to increase until reaching its highest temperature (about 205.7° C.) after about 194 seconds. The temperature then gradually decreases.

As shown in graph AI2 of FIG. 6, the temperature of the bottom edge of the pure aluminum alloy pot reaches its maximum temperature (about 118.9° C.) after about 269 seconds. The temperature then gradually decreases.

As shown in graph AI1 of FIG. 6, the temperature of the rim of the pure aluminum alloy pot reaches its maximum temperature (about 83.8° C.) after about 312 seconds. The temperature then gradually decreases.

When the temperature detection is performed on the pure aluminum alloy pot, the ambient temperature is constantly maintained at about 20° C., as shown in graph AI5 of FIG. 6.

In addition, as shown in graph AI3 and graph AI2 of FIG. 6, when the pure aluminum alloy pot is heated to a temperature of 200° C., the temperature difference between the maximum temperature at the bottom center of the pot and the maximum temperature at the bottom edge of the pot is about 86.8° C.

According to the experimental results, the degree of thermal uniformity of the pure aluminum alloy pot that is heated to 200° C. can be calculated using formula (1) above.

$$100 \% - [ ( 205.7 - 118.9 ) / 205.7 ] * 100 \% = 57.8 \%$$

According to the experimental results in FIG. 7, the analysis of surface temperature distribution of the pot with conventional nonstick coating is provided below.

As shown in graph AI3 of FIG. 7, when the pot with conventional nonstick coating is heated to a temperature of 200° C., the temperature at the bottom center of the pot continues to increase until reaching its highest temperature (about 202.3° C.) after about 171 seconds. The temperature then gradually decreases.

As shown in graph AI2 of FIG. 7, the temperature of the bottom edge of the pot with conventional nonstick coating reaches its maximum temperature (about 150° C.) after about 171 seconds. The temperature then gradually decreases.

As shown in graph AI1 of FIG. 7, the temperature of the rim of the pot with conventional nonstick coating reaches its maximum temperature (about 89.9° C.) after about 241 seconds. The temperature then gradually decreases.

When the temperature detection is performed on the pot with conventional nonstick coating, the ambient temperature is constantly maintained at about 20° C., as shown in graph AI5 of FIG. 7.

In addition, as shown in graph AI3 and graph AI2 of FIG. 7, when the pot with conventional nonstick coating is heated to a temperature of 200° C., the temperature difference between the maximum temperature at the bottom center of the pot and the maximum temperature at the bottom edge of the pot is about 52.3° C.

According to the experimental results, the degree of thermal uniformity of the pot with conventional nonstick coating that is heated to 200° C. can be calculated using formula (1) above:

$$100 \% - [ ( 202.3 - 150 ) / 202.3 ] * 100 \% = 74 \%$$

According to the experimental results in FIG. 8, the analysis of surface temperature distribution of the pot with an embodied coating structure is provided below.

As shown in graph AI3 of FIG. 8, when the pot with an embodied coating structure is heated to a temperature of 200° C., the temperature at the bottom center of the pot continues to increase until reaching its highest temperature (about 203.8° C.) after about 164 seconds. The temperature then gradually decreases.

As shown in graph AI2 of FIG. 8, the temperature of the bottom edge of the pot with an embodied coating structure reaches its maximum temperature (about 166.5° C.) after about 163 seconds. The temperature then gradually decreases.

As shown in graph AI1 of FIG. 8, the temperature of the rim of the pot with an embodied coating structure reaches its maximum temperature (about 103.5° C.) after about 224 seconds. The temperature then gradually decreases.

When the temperature detection is performed on the pot with an embodied coating structure, the ambient temperature is constantly maintained at about 20° C., as shown in graph AI5 of FIG. 8.

In addition, as shown in graph AI3 and graph AI2 of FIG. 8, when the pot with an embodied coating structure is heated to a temperature of 200° C., the temperature difference between the maximum temperature at the bottom center of the pot and the maximum temperature at the bottom edge of the pot is only about 37.3° C.

According to the experimental results, the degree of thermal uniformity of the pot with an embodied coating structure that is heated to 200° C. can be calculated using formula (1) above:

$$100 \% - [ ( 203.8 - 166.5 ) / 203.8 ] * 100 \% = 81.7 \%$$

According to the detection results of the above-mentioned surface temperature distribution, it has indicated that the pot with a coating structure of the embodiment, whether the bottom center, the bottom edge or the rim of pot, can reach its maximum temperature faster than the pots in the comparative experiments (such as the commercial stainless steel pot, the pure aluminum alloy pot and the pod with conventional nonstick coating). In addition, the maximum temperature at the bottom edge of the pot with a coating structure of the embodiment is greater than the maximum temperatures at the bottom edges of the pots used in the comparative experiments. According to the calculation using formula (1), the coating structure of the embodiment does greatly improve the thermal uniformity of the pot (e.g., up to about 82%). Therefore, the coating structure of the embodiment does have better thermal uniformity property.

### Comparison of Coating Layers

In the experiments, several composite coatings were prepared on the surfaces of the pots, and some commercially available pots (with or without coatings) were used in the experiments as comparative examples. Many tests were performed on those pods. Table 5 lists results of one embodied composite coating layer (i.e., prepared from the raw materials of powder mixture I (25 parts by weight of metal oxide) on an aluminum substrate; hereinafter referred to as Example I) and five comparative examples of substrates and/or coatings. The comparative examples include a composite coating layer that was made from the raw materials of powder mixture II (hereinafter referred to as the composite coating layer of Comparative Example II) and another composite coating layer that was made from the raw materials of powder mixture III (hereinafter referred to as the composite coating layer of Comparative Example III).

TABLE 5

| | Sample | | | |
|---|---|---|---|---|
| | Composite | | | |
| | coating layer of | | | Teflon coating |
| | Example I (on | | 304 stainless | layer (on an |
| | an Al substrate) | Al substrate | steel substrate | Al substrate) |
| | Embodied | Comparative | Comparative | Comparative |
| Test item | Example | Example | Example | Example |
| Surface | Ra = 3.25 μm | Ra = 2.56 μm | Ra = 1.10 μm | Ra = 1.55 μm |
| roughness | | | | |
| Adhesion | 9200 Psi | 6240 Psi | 10272 Psi | — (no adhesion |
| strength | | | | test since the |
| | | | | adhesion test |
| | | | | required |
| | | | | specimen with |
| | | | | metallic |
| | | | | opposite ends |
| Dry sand | After 30 | After 30 | After 30 | After 10 |
| abrasion test | seconds, the | seconds, weight | seconds, weight | seconds, the |
| | substrate is | loss of abrasion | loss of abrasion | substrate is |
| | exposed, and | is 0.0829 g. | is 0.0639 g. | exposed, and |
| | weight loss of | | | weight loss of |
| | abrasion is | | | abrasion is |
| | 0.0565 g. | | | 0.0500 g. |
| Hardness test | Hv_{0.1} 565.0 ± 45.8 | Hv_{0.025} 89.0 ± 1 | Hv_{0.3} 186.5 ± 4.8 | NG (too soft) |
| Empty pot | 169 seconds | 213 seconds | 193 seconds | 240 seconds |
| heating test | (82% of thermal | (57.8% of thermal | (65% of thermal | (74% of thermal |
| | uniformity) | uniformity) | uniformity) | uniformity) |
| Water boiling | Water boiling | Water boiling | Water boiling | Water boiling |
| test | time: 2 min. 5 | time: 2 min. 53 | time: 3 min. 30 | time: 2 min. 44 |
| | sec. | sec. | sec. | sec. |
| Oil streak | Oleophobic | Oleophilic | Oleophilic | Oleophobic |
| observation | Time: 1 min. 14 | Time: 1 min. 07 | Time: 1 min. 12 | Time: 1 min. 11 |
| | sec. 84 | sec. 37 | sec. 34 | sec. 96 |
| Thermal | The largest | Medium range of | Medium range | Large range of |
| radiation of oil | range of heating | heating area | of heating area | heating area |
| at 150° C. | area | | | |

Sample

| | Composite coating | Composite coating |
|---|---|---|
| | layer of Comparative | layer of Comparative |
| | Example II | Example III |
| | (on an Al substrate) | (on an Al substrate) |
| Test item | Comparative Example | Comparative Example |
| Surface roughness | Ra = 4.73 μm | Ra = 4.71 μm |
| Adhesion strength | 5640 Psi | 4800 Psi |
| Dry sand abrasion | After 10 seconds, the | After 20 seconds, the |
| test | substrate is exposed, | substrate is exposed, |
| | and weight loss of | and weight loss of |
| | abrasion is 0.0905 g. | abrasion is 0.0621 g. |
| Hardness test | Hv_{0.1} 812.9 ± 76.6 | Hv_{0.1} 733.8 ± 78.5 |
| Empty pot heating | 301 seconds | 277 sseconds |
| test | | |
| Water boiling test | Water boiling time: | Water boiling time: |
| | 2 min. 52 sec. | 2 min. 58 sec. |
| Oil streak | Oleophobic | Oleophobic |
| observation | Time: 1 min. 15 sec. 47 | Time: 1 min. 15 sec. 47 |
| Thermal radiation | Large range of | Large range of |
| of oil at 150° C. | heating area | heating area |

Tests and its results are briefly described below.

According to the measurement results of surface roughness Ra (centerline average roughness) of the above-mentioned composite coating layers of Example I, Comparative Example II and Comparative Example III, all of the composite coating layers, each containing Ni, Ti, Zr and O, have relatively high surface roughness Ra. For example, the surface roughness Ra of the composite coating layer of Example I is more than twice the surface roughness Ra of the Teflon coating layer. The coating layer, i.e., Example I, with relatively high surface roughness Ra presents higher anti-sticking property.

Although the surface roughness Ra of each of the composite coating layers of Comparative Example II and Comparative Example III is higher than the surface roughness Ra of the composite coating layer of Example I, the adhesion strengths (i.e., coating tensile strength) (5640 Psi and 4800 Psi) are much less than the adhesion strength (9200 Psi) of the composite coating layer in Example I. Thus, the composite coating layers of Comparative Example II and Comparative Example III are easier to peel off from the substrate. The results of adhesion strength also correlate with the results of the abrasion test. According to the results of the abrasion test, the composite coating layer of Comparative Example II has a weight loss of 0.0905 g after 10 second rubbing (based on the time that the substrate is exposed), and the composite coating layer of Comparative Example III has a weight loss of 0.0621 g after 20 second rubbing. It took 30 seconds for the composite coating layer of

Example I to expose the substrate, and the weight loss is only 0.0565 g, which is less than the weight loss of the composite coating layers of Comparative Examples II and III. Thus, the composite coating layer of Example I has better performance of abrasion resistance, in accordance with some embodiments of the present disclosure.

According to the aforementioned descriptions, the composite coating layer that are melted and sprayed from an initial powder mixture containing too much ceramic material would have lower abrasion resistance. However, the composite coating layer of the embodiments that includes Ni, Ti, Zr and O in certain proportion ranges has not only good adhesion strength but also good abrasion resistance.

In addition, the composite coating layers of Example I, Comparative Example II and Comparative Example III have quasicrystalline structural phases, so all three composite coating layers have relatively high hardness. Among them, the quasicrystalline content in each of the composite coating layers of Comparative Examples II and Comparative Examples III is greater than the quasicrystalline content of the composite coating layer of Example I. The hardness of each of the composite coating layers of Comparative Examples II and Comparative Examples III is also greater than the hardness of the composite coating layer of Example I. However, the adhesion strengths of the composite coating layers of Comparative Example II and Comparative Example III also decreased. According to the discussions above, the composite coating layer of the embodiment that does not contain an excessively high content of quasicrystalline structures has sufficient hardness and good adhesive strength. For example, the quasicrystalline structure phase is in a range of about 10 wt % to about 40 wt %, or about 20 wt % to about 25 wt %, based on the total weight of the composite coating layer of the embodiment.

The empty pot heating test can refer to the relevant descriptions of the above-mentioned surface temperature distribution detection. Some of the empty pots that are coated with the composite coating layers and the substrates of the other empty pots without coating, in accordance with the embodied examples and comparative examples, were heated to 200° C. In addition, according to the above descriptions, the thermal uniformities of these pots can be calculated using formula (1). Table 5 also lists the time required for these pots to be heated to 200° C., as well as the degree of thermal uniformity. According to the experimental results, the composite coating layer of Example I reaches 200° C. first and has the highest degree of thermal uniformity (about 81.7%). This means that heat is rapidly transferred from the substrate to the rough surface of the composite coating layer of the embodiment, and the pot surface thus quickly achieves high thermal uniformity.

The water boiling test can refer to the relevant descriptions of the above-mentioned boiling test. Table 5 also lists the time required for these pots to heat and boil water. According to the experimental results, the composite coating layer of Example I boils the water first, and the bubbles generated in the water were evenly distributed over the entire surface of the pot bottom. This also means that heat can be rapidly and evenly transferred to the rough surface of the composite coating layer of the embodiment, and the pot surface thus quickly achieves high thermal uniformity.

In the oil streak observation, an equal amount of oil was added to these pots, and the coating layer or the substrate of each pot was observed to determine whether the coating layer or the substrate is oleophobic or oleophilic. In addition, the time for heating the oil in the pot to reach a certain temperature (150° C.) was also record and listed in Table 5. According to the experimental results as listed in Table 5, the composite coating layers of Example I, Comparative Example II and Comparative Example III were all oleophobic, and the oil film on each of the composite coating layers tended to form droplets dispersed in various areas. The oil film quickly forms droplets that are widely dispersed facilitates well stir-frying food in the pot. In addition, the oil films on the composite coating layers of Example I, Comparative Example II and Comparative Example III quickly reached a predetermined temperature (for example, about 150° C.).

In the thermal radiation experiment of 150° C., the temperature distribution of the oil at 150° C. in the pots of the embodiment and comparative examples were detected by an infrared thermal image system. According to the experimental results, compared to the aluminum pot and the stainless steel pot of the comparative examples, the composite coating layers of Example I, Comparative Example II and Comparative Example III have larger ranges of heating area. Among them, the composite coating layer of Example I has the largest heating area.

According to some embodiments of the present disclosure, the proposed coating structure that includes a composite coating layer has rapid thermal conductivity and good thermal uniformity. As described above, the composite coating layer of some embodiments can be prepared by providing a powder mixture that includes several metal materials and one or more ceramic materials, melting the powder mixture, and spraying the molten mixed materials on the surface of the substrate. Form a composite coating. Due to the selection of materials, the composite coating of the embodiment is made by thermal spraying or plasma spraying, because the metal with a lower melting point forms a liquid during the spraying process to fill the gaps in the coating, forming the relatively dense coating structure and the matching of different melting points of each element also form a rough surface with no specific shape on the coating surface, so that the prepared composite coating has anti-stick, abrasion resistant and corrosion-resistant properties. According to the embodiments, the composite coating layer can be formed by thermal spraying or plasma spraying. During the thermal spraying process or plasma spraying process, one of more metal materials of the composite coating layer, which has a lower melting point and is in the liquid state, may flow to fill pores and/or seams in the coating layer, thereby forming a denser coating structure. In addition, the combinations of any two or more of the selected materials that have different melting points will form a rough surface of the composite coating layer after the thermal spraying process is performed. Therefore, the composite coating layer of the embodiments has nonstick, abrasion resistant and corrosion resistant properties. In addition, when the composite coating layer of the embodiment is applied to a heating device, the composite coating layer or the coating structure that further includes another material (such as a sealing layer) can achieve a high degree of thermal uniformity. In some embodiments, the composite coating layer that includes Ni, Ti, Zr and O elements in a specific content range has quasicrystalline structures. In addition, in some embodiments, the abrasion test result shows that more end portions of the quasicrystals are exposed on the surface of the composite coating layer after rubbing. Therefore, the composite coating layer of the embodiment has high hardness and good abrasion resistance due to the presence of the quasicrystalline structures. In summary, compared to the conventional coatings on the pots, the coating structure that includes the composite coating layer of the embodiments has many excellent properties such as rapid and even dispersion of heat energy, nonstick property, good abrasion resistance (i.e., good adhesion strength) and good corrosion resistance. In addition, the method for forming the composite coating layer of the embodiments is simple and can reduce the limitations on substrate selection. In addition to being applied to stainless steel substrates, carbon steel substrates and ceramic substrates, the composite coating layer of the embodiments can also be applied to aluminum substrates that are not thermal stability at high temperature annealing.

While the present disclosure has been described by way of example and in terms of the preferred embodiments, it should be understood that the present disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

### DESCRIPTION OF SYMBOLS

100: substrate
100a: first surface
10,20: coating structure
210: composite coating layer
210a,220a: surface
210P: protrusions
220: sealing layer
AI1,AI2,AI3,AI5: graph
L1,L2,L3: Example graph

1. A composite coating layer, comprising:
4.3 wt % to 7.6 wt % carbon (C), 9.5 wt % to 21.8 wt % oxygen (O), 1.2 wt % to 3.5 wt % aluminum (Al), 23.5 wt % to 42.6 wt % titanium (Ti), 16.8 wt % to 41 wt % nickel (Ni) and 14.3 wt % to 23.7 wt % zirconium (Zr).

2. The composite coating layer as claimed in claim 1, having quasicrystalline structural phases, wherein a content of the quasicrystalline structural phases is in a range of 10 wt % to 40 wt % based on a total weight of the composite coating layer.

3. The composite coating layer as claimed in claim 1 having quasicrystalline structural phases, wherein a content of the quasicrystalline structural phases is in a range of 20 wt % to 25 wt % based on a total weight of the composite coating layer.

4. A coating structure, comprising:
a substrate; and
a composite coating layer over the substrate, wherein the composite coating layer comprises 4.3 wt % to 7.6 wt % carbon (C), 9.5 wt % to 21.8 wt % oxygen (O), 1.2 wt % to 3.5 wt % aluminum (Al), 23.5 wt % to 42.6 wt % titanium (Ti), 16.8 wt % to 41 wt % nickel (Ni) and 14.3 wt % to 23.7 wt % zirconium (Zr), wherein the composite coating layer has a rough surface, and a surface roughness of the rough surface is in a range of 1 μm to 50 μm.

5. The coating structure as claimed in claim 4, wherein the surface roughness of the rough surface is in a range of 3 μm to 4.5 μm.

6. The coating structure as claimed in claim 4, wherein the substrate comprises aluminum alloy, stainless steel, carbon steel or one or more ceramic materials.

7. The coating structure as claimed in claim 4, wherein the composite coating layer is a multilayer structure, and a thickness of the composite coating layer is in a range of 50 μm to 150 μm.

8. The coating structure as claimed in claim 4, further comprising:
a sealing layer, conformally formed on the rough surface of the composite coating layer.

9. The coating structure as claimed in claim 8, wherein the sealing layer comprises a polymer material.

10. The coating structure as claimed in claim 9, wherein a thickness of the sealing layer is in a range of 10 μm to 500 μm.

11. A heating device, comprising:
the composite coating layer of claim 1, wherein the composite coating layer comprises quasicrystalline structural phases that are in a range of 10 wt % to 40 wt % based on a total weight of the composite coating layer.

12. The heating device as claimed in claim 11, wherein the composite coating layer has a rough surface, and a surface roughness of the rough surface is in a range of 1 μm to 50 μm.
